(19) United States
(12) Patent Application Publication
(10) Pub. No.: US 2017/0038942 A1
(43) Pub. Date: Feb. 9, 2017

(54) PLAYBACK INITIALIZATION TOOL FOR PANORAMIC VIDEOS

(71) Applicants: Alex Rosenfeld, Santa Monica, CA (US); Kuangwei Hwang, Los Angeles, CA (US); Sean Lawrence, Washington DC, DC (US)

(72) Inventors: Alex Rosenfeld, Santa Monica, CA (US); Kuangwei Hwang, Los Angeles, CA (US); Sean Lawrence, Washington DC, DC (US)

(73) Assignee: Vrideo, Los Angeles, CA (US)

(21) Appl. No.: 15/231,540

(22) Filed: Aug. 8, 2016

Related U.S. Application Data
(60) Provisional application No. 62/202,690, filed on Aug. 7, 2015.

(51) Int. Cl. G06F 3/0481; G06F 3/0484; H04N 5/232

(52) U.S. Cl. CPC G06F 3/04815; H04N 5/23238; G06F 3/04842; G06F 3/04847

(57) ABSTRACT

A method for initializing a panoramic video by a graphical user interface (GUI) includes receiving a panoramic video, creating a three-dimensional mesh, and displaying a preview rendered from the three-dimensional mesh. The GUI displays a time selection interface and selects a frame time in the panoramic video with the time selection interface. The GUI displays a view selection interface and selects view parameters that define a camera orientation at the frame time of the panoramic video with the view selection interface. The GUI determines a selected frame of the panoramic video defined by the frame time and the view parameter, renders the thumbnail from the three-dimensional mesh based on the selected frame, and stores orientation data including the frame time and the view parameters.

### CROSS-REFERENCE TO RELATED APPLICATION

This application claims the benefit of U.S. Provisional Patent Application Ser. No. 62/202,690 entitled “VIEW ORIENTATION TOOL FOR PANORAMIC VIDEO”, which was filed Aug. 7, 2015 and U.S. Provisional Patent Application Ser. No. 62/202,706 entitled “THUMBNAIL CREATION TOOL FOR PANORAMIC VIDEO”, which was filed Aug. 7, 2015. The aforementioned applications are herein incorporated by reference in its entirety.

### BACKGROUND

Field

This application relates to digital video processing, and more particularly to a system and method for initializing a panoramic video.

Background

Video sharing websites allow a large number of videos to be viewable by users. When a user looks for video content, the user may be shown thumbnail images representative of viewable videos. There is a need to generate a thumbnail image representative of each video. A thumbnail is generally chosen from a particular frame of a video that is both visually stimulating and representative of the content in the video. However, generating a thumbnail for a panoramic video can be significantly more complex than merely selecting a video frame.

Additionally, once the user finds a particular panoramic video for playback, the panoramic video may start playing with the initial view orientation skewed at an angle that causes disorientation or confusion for the viewer. Traditional videos (also called “framed” videos) generally do not have view orientation options and are limited to a single viewing orientation. In contrast, panoramic videos may allow a viewer to adjust a viewing orientation or camera angle for viewing. However, the ability for the panoramic videos to be viewed from various angles also means that a user's view initial orientation at the start of playback may be unideal or unintended by a content creator of a panoramic video.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In accordance with one or more aspects of the examples described herein, systems and methods are provided for initializing a panoramic video.

In an aspect, a playback initialization tool receives a panoramic video, creates a three-dimensional mesh, displays a time selection interface, and selects a frame time in the panoramic video with the time selection interface. The playback initialization tool displays a view selection interface and selects view parameters that define a camera orientation at the frame time of the panoramic video with the view selection interface. The playback initialization tool determines a selected frame of the panoramic video defined by the frame time and the view parameters and renders the thumbnail from the three-dimensional mesh based on the selected frame.

In a second aspect a view orientation tool receives a panoramic video, creates a three-dimensional mesh, and displays a preview rendered from the three-dimensional mesh. The view orientation tool displays a time selection interface and selects a frame time in the panoramic video with the time selection interface. The view orientation tool displays a view selection interface and selects view parameters that define a camera orientation at the frame time of the panoramic video with the view selection interface. The view orientation tool stores orientation data including the frame time and the view parameters.

In a third aspect, a method for initializing a panoramic video by a graphical user interface (GUI) includes receiving a panoramic video, creating a three-dimensional mesh, and displaying a preview rendered from the three-dimensional mesh. The GUI displays a time selection interface and selects a frame time in the panoramic video with the time selection interface. The GUI displays a view selection interface and selects view parameters that define a camera orientation at the frame time of the panoramic video with the view selection interface. The GUI determines a selected frame of the panoramic video defined by the frame time and the view parameter, renders the thumbnail from the three-dimensional mesh based on the selected frame, and stores orientation data including the frame time and the view parameters..

### BRIEF DESCRIPTION OF THE DRAWINGS

These and other sample aspects of the present technology will be described in the detailed description and the appended claims that follow, and in the accompanying drawings, wherein:

FIG. 1 illustrates a GUI of an example time selection interface;

FIG. 2 illustrates a GUI of an example view selection interface;

FIG. 3 illustrates a flow diagram of an example graphics pipeline in the prior art;

FIG. 4 illustrates an example methodology for creating a thumbnail for a panoramic video;

FIG. 5 illustrates an example methodology for setting camera orientation for a panoramic video; and

FIG. 6 illustrates a block diagram of an example computer system.

### DETAILED DESCRIPTION

The subject disclosure provides techniques for initializing a panoramic video, in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

In some implementations, a thumbnail creation tool is made available to users (e.g., video creators, video curators, advertisers, video directors) for generating a thumbnail that allows quick preview of a panoramic video by viewers of the thumbnail. The thumbnail creation tool can create a thumbnail of a frame at any camera viewing angle and at any playback time of the video. A user can use the thumbnail creation tool to easily adjust the region-of-interest and generate a framed thumbnail out of a panoramic video which have no frames.

For example, the thumbnail can be generated as a 16:9 aspect ratio image. Multiple thumbnails can be arranged in a two-dimensional user interface to help viewers browse and find interesting panoramic videos to watch.

In some implementations, a view orientation tool is made available to the users to adjust a view orientation (i.e., camera angle) for one or more points in time of a panoramic video. For example, the view orientation tool can set a starting camera view orientation to begin playing the panoramic video. This allows a view orientation tool user to ensure that viewers of the panoramic video begin playing the panoramic video at a relevant/interesting camera view orientation. A properly selected starting camera view prevents viewers from being disoriented or confused at the start of the panoramic video playback.

In another example, the view orientation tool can set a default camera view orientation during one or more specific points in time of the panoramic video to help direct the viewer to areas of interest. For example, as the viewer watches the panoramic video during playback, the camera can rotate and/or zoom automatically to areas of interest set by the view orientation tool user.

In some implementations, the time selection interface and camera view selection interface are combined into a single user interface, such as for example a graphical user interface (GUI), for simplification. The user of the single user interface can go back and forth between selecting a time and selecting a camera orientation.

In some implementations, the thumbnail creation tool shows a preview of the frame at the selected time and camera orientation of the panoramic video. The thumbnail creation tool can re-render each frame of the panoramic video when reselected to update the preview.

The thumbnail creation tool can be used to capture a still image of a portion of a panoramic frame of a panoramic video. The thumbnail creation tool can render a panoramic image that has been stitched from one of various types of image projections. Stitching is a process of combining multiple photographic images with overlapping fields of view to produce a segmented panorama or high-resolution image.

An image projection can occur whenever a flat image is mapped onto a curved surface, or vice versa, and can be used in panoramic photography and videography. For example, a projection can be performed when a cartographer maps a spherical globe of the earth onto a flat piece of paper, for example.

Example types of projections can include equirectangular, cylindrical, rectilinear, fisheye, sinusoidal, and stereographic. The image projections can for example be mapped over a spherical or cylindrical three-dimensional shape.

Equirectangular image projections can map the latitude and longitude coordinates of a spherical globe directly onto horizontal and vertical coordinates of a grid, where this grid is roughly twice as wide as it is tall. Equirectangular projections can show the entire vertical and horizontal angle of camera view up to 360 degrees. For example, one or more cameras can capture a series of camera frames. The cameras can use each wide angle or fisheye lenses. The cameras can be configured in such an arrangement in which every angle is captured. The camera frames from all the cameras can be stitched together using stitching software that uses a variety of image stitching algorithms to combine the camera frames into an equirectangular projection.

Cylindrical image projections can be similar to equirectangular image projections, except it also vertically stretches objects as they get closer to the north and south poles, with infinite vertical stretching occurring at the poles. Therefore, cylindrical projections may not be suitable for images with a very large vertical angle of camera view.

Rectilinear image projections can map all straight lines in three-dimensional space to straight lines on the flattened two-dimensional grid. Rectilinear image projections can greatly exaggerate perspective as the angle of camera view increases, leading to objects appearing skewed at the edges of camera view. Rectilinear projections are generally not used for angles of camera view much greater than 120 degrees.

Fisheye image projections can create a flattened grid where a distance from the center of the flattened grid is roughly proportional to actual viewing angle, to create an image that looks similar to the reflection off of a metallic sphere.

Sinusoidal image projections can maintain equal areas throughout all grid sections.

In some implementations, the thumbnail creation tool can allow for manual selection of a thumbnail from a panoramic video. In some other implementations, the thumbnail creation tool can automatically create a thumbnail from a panoramic video.

In some implementations, the thumbnail creation tool can, project onto a three-dimensional sphere, and store frames of the panoramic video at a regular time interval (e.g., every five seconds). A user of the thumbnail creation tool can use a time selection interface to allow the user select a frame time in the video at one of the regular time interval of which frames are previously stored.

In some other implementations, the thumbnail creation tool uses the time selection interface to allow the user to first select a specific frame time. The thumbnail creation tool then project and store a frame of the panoramic video corresponding to the selected specific frame time.

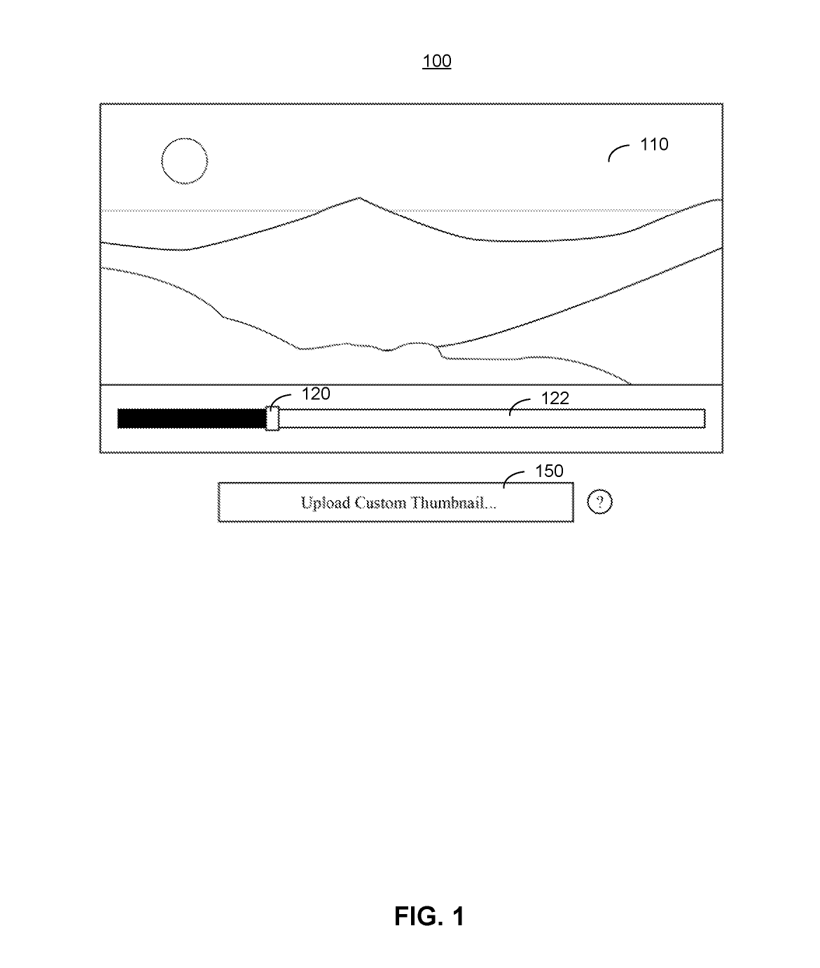

FIG. 1 illustrates a GUI 100 of an example time selection interface. For example, the time selection interface can be a slider mechanism 122 to select or adjust/reselect a frame time between the beginning and the end of the video. A use can select and drag a handle 120 on a slider to scroll from the beginning to the end of the video. The furthest position left on the slider can be at the beginning of the video. The furthest position right on the slider can be at the end of the video. In some implementations, the time selection interface displays a preview 110 of a still image at the selected frame time.

In some implementations, the GUI 100 includes a button 150 or other interface for uploading a custom image to use as the thumbnail for the panoramic video. The custom image is then shown in the preview 110.

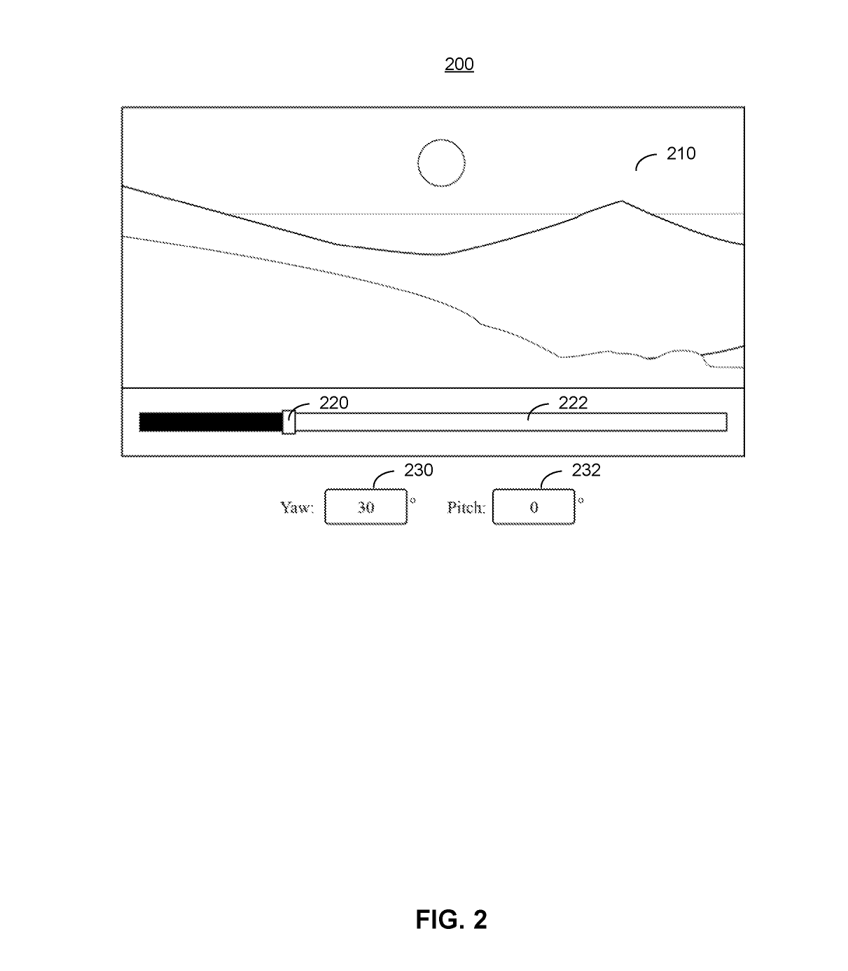

FIG. 2 illustrates a GUI 200 of an example view selection interface. The view selection interface includes a virtual camera with pan (also referred to as yaw), tilt (also referred to as pitch), and zoom controls 230, 232 to select/change a camera view for use in creating a thumbnail. The view selection interface allows the user to select the camera view for the thumbnail, defined by view parameters, shown by the virtual camera. In some implementations, the user can adjust a camera view shown by a preview 210 of a still image at the selected camera view. In some implementations, the user can drag a cursor's (e.g., with mouse or touchscreen) position across a camera viewing plane to adjust/rotate (e.g., pan, tilt, or roll) a camera orientation of the panoramic image displayed by the thumbnail. In some implementations, the time selection interface and camera view selection interface are combined into a single GUI, where the GUI 200 of view selection interface also includes a time selection interface 220, 222 similar to the GUI 100 of FIG. 1.

For example, selecting and dragging the cursor along the X and Y axis of a two-dimensional screen can rotate the camera orientation around the X and Y rotational axis in three-dimensional space. The thumbnail creation tool can calculate the amount of rotation of the camera orientation based on a distance of travel of the mouse cursor in the two-dimensional screen. In some implementations, the user can zoom in or out of the camera view using at least one of keyboard, mouse, touchscreen, trackball, joystick, or other input device. In some implementations, the view selection interface can include text boxes 230, 232 for a user to manually enter of the orientation by typing in Euler angles desired.

In some implementations, the thumbnail creation tool creates the three-dimensional mesh and places the virtual camera at the center of the three dimensional mesh. The selected camera view for creating the thumbnail corresponds to a portion of a three-dimensional mesh space. For example, the three-dimensional mesh can be a sphere or a variety of other shapes depending on how the camera frames were stitched together. The shape is used by an algorithm to un-distort the stitched camera frame.

A mesh is a collection of vertices, edges and faces that defines the shape of a polyhedral object for use in three-dimensional modeling. The faces usually include triangles, quadrilaterals, or other simple convex polygons, but can also include more general concave polygons, or polygons with holes. A vertex is a position (usually in 3D space) along with other information such as color, normal vector and texture coordinates. An edge is a connection between two vertices. A face is a closed set of edges (e.g., a triangle face has tree edges and a quad face has four edges).

Polygon meshes may be represented in a variety of ways, using different methods to store the vertex, edge and face data. Examples of polygon mesh representations include Face-vertex meshes, Winged-edge meshes, Half-edge meshes, Quad-edge meshes, Corner-table meshes, and Vertex-vertex meshes.

In some other implementations, the thumbnail creation tool can display an equirectangular image as a panoramic video plays without using a mesh. The view orientation tool can create a “square” (e.g., by using two triangles or six vertices) and projecting each pixel of a frame of the video onto the square based on a predefined algorithm for a type of three-dimensional projection. Three-dimensional projections are methods of mapping three-dimensional points to a two-dimensional plane. An image projection can occur whenever a flat image is mapped onto a curved surface, or vice versa, and can be used in panoramic photography and videography.

For example, a projection can be performed when a cartographer maps a spherical globe of the earth onto a flat piece of paper, for example. Example types of projections can include equirectangular, cylindrical, rectilinear, fisheye, sinusoidal, and stereographic. The image projections can for example be mapped over a spherical or cylindrical three-dimensional shape. One or more cameras can capture a series of frames. For example, the cameras can use each wide angle or fisheye lenses. The cameras can be configured in such an arrangement in which every angle is captured. The frames from all the cameras can be stitched together using stitching software that uses a variety of image stitching algorithms to combine the frames into an equirectangular projection.

The thumbnail creation tool uses a graphics pipeline or rendering pipeline to create a two-dimensional representation of a three-dimensional scene. For example, OpenGL and DirectX are two of the most commonly used graphics pipelines.

Stages of the graphics pipeline include creating a scene out of geometric primitives (i.e., simple geometric objects such as points or straight line segments). Traditionally this is done using triangles, which are particularly well suited to this as they always exist on a single plane. The graphics pipeline transforms form a local coordinate system to a three-dimensional world coordinate system. A model of an object in abstract is placed in the coordinate system of the three-dimensional world. Then the graphics pipeline transforms the three-dimensional world coordinate system into a three-dimensional camera coordinate system, with the camera as the origin.

The graphics pipeline then creates lighting, illuminating according to lighting and reflectance. The graphics pipeline then performs projection transformation to transform the three-dimensional world coordinates into a two-dimensional view of a two-dimensional camera. In the case of a perspective projection, objects which are distant from the camera are made smaller. Geometric primitives that now fall completely outside of the viewing frustum will not be visible and are discarded.

Next the graphics pipe performs rasterization. Rasterization is the process by which the two-dimensional image space representation of the scene is converted into raster format and the correct resulting pixel values are determined. From now on, operations will be carried out on each single pixel. This stage is rather complex, involving multiple steps often referred as a group under the name of pixel pipeline.

In some implementations, the thumbnail creation tool performs projecting and rasterizing based on the virtual camera. For example, each pixel in the image can be determined during the rasterizing to create the two-dimensional image. This two-dimensional image can then be saved and stored as a thumbnail.

Lastly, the graphics pipeline assigns individual fragments (or pre-pixels) a color based on values interpolated from the vertices during rasterization, from a texture in memory, or from a shader program. A shader program calculates appropriate levels of color within an image, produce special effects, and perform video post-processing. Shader programs calculate rendering effects on graphics hardware with a high degree of flexibility. Most shader programs use a graphics processing unit (GPU).

When a stitched together camera frame is mapped over the three-dimensional mesh, the graphics pipeline can interpolate between vertexes of the mesh. The number of vertices of the mesh is a factor in how well an image can be rendered. A higher number of vertices can provide a better image rendering, but can be more time consuming to render by computer hardware. Each vertex can represented as a three dimensional coordinate with and X, Y and Z parameter.

Interpolation is the filling in of frames between the key frames. It typically calculates the in between frames through use of (usually) piecewise polynomial interpolation to draw images semi-automatically. Interpolation gives the appearance that a first frame evolves smoothly into a second frame.

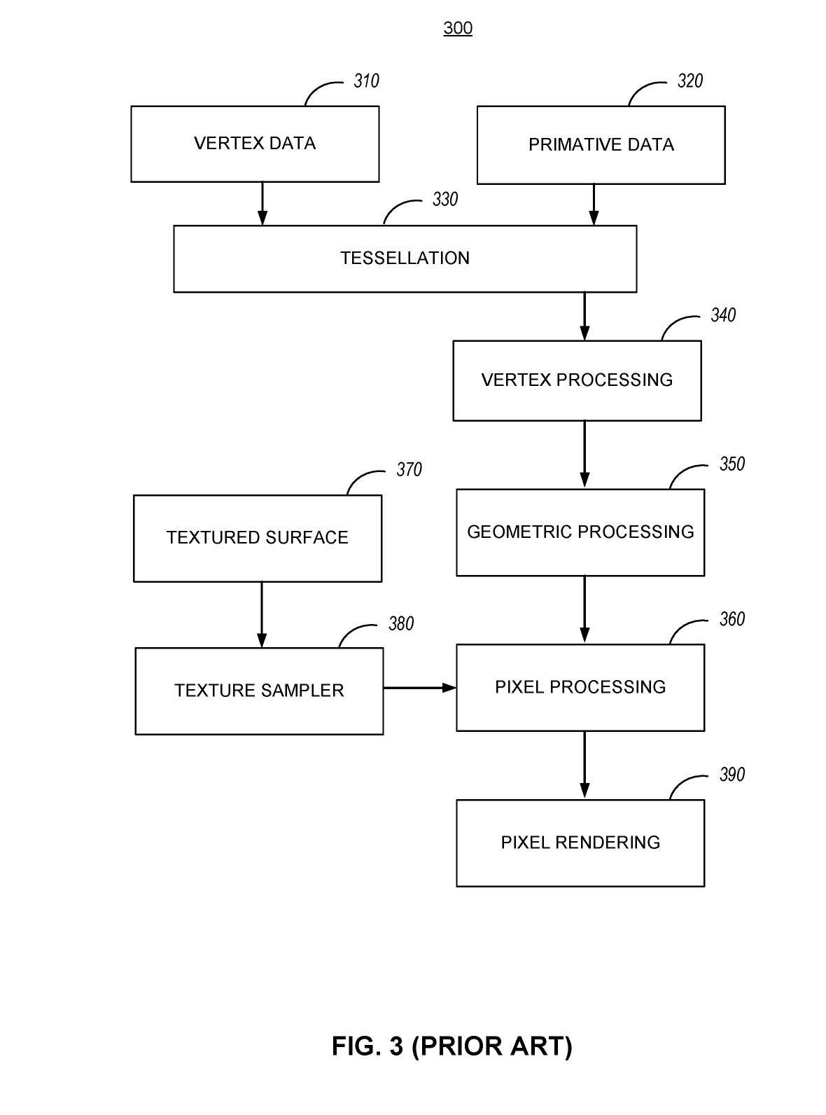

FIG. 3 illustrates a flow diagram 300 of an example graphics pipeline in the prior art. At step 310 untransformed model vertices are stored in vertex memory buffers. At step 320 geometric primitives, including points, lines, triangles, and polygons, are referenced in the vertex data with index buffers. At step 330, tessellation converts higher-order primitives, displacement maps, and mesh patches to vertex locations and stores those locations in vertex buffers. At step 340, transformations are applied to vertices stored in the vertex buffer. At step 350, clipping, back face culling, attribute evaluation, and rasterization are applied to the transformed vertices. At step 360, Pixel shader operations use geometry data to modify input vertex and texture data, yielding output pixel color values. At step 370, texture coordinates are supplied. At step 380 texture level-of-detail filtering is applied to input texture values. At step 390 final rendering processes modify pixel color values with alpha, depth, or stencil testing, or by applying alpha blending or fog.

In some implementations, the thumbnail creation tool includes a viewing buffer that includes a collection of red green blue alpha (RGBA) values at each pixel within the dimensions that make up the selected frame. The thumbnail creation tool can then serialize and save the viewing buffer as an image file in any image format. For example, the image format can include a compression format such as JPEG, portable network graphics (PNG), etc.

The view orientation tool can be used to set a camera orientation (i.e., camera angle) for one or more points in time of a panoramic video. The view orientation tool stores view parameters including orientation data and/or zoom level.

For example, the user of the view orientation tool can choose to initialize the viewer's orientation at the beginning of video playback. The view orientation tool can be used to initialize the viewer toward the most interesting part of the panoramic video, or adjust for alignment issues (e.g., the horizon) to enhance the viewer's experience.

In another example, the view orientation tool user can choose to set the viewer's orientation towards the most interesting part of the panoramic video throughout the panoramic video playback.

For example, the orientation data can include Euler angles. Euler angles represent a sequence of three elemental rotations (i.e. rotations about the three axes of a coordinate system). For instance, a first rotation about z by an angle α, a second rotation about x by an angle β, and a third rotation again about z, by an angle γ. The three axes of rotations are sometimes referred to as pan, tilt, and roll. These rotations start from an initial orientation. Any orientation can be achieved by composing three elemental rotations.

In some implementations, the orientation data can include Euler angles for all points in time throughout an entire panoramic video. In some implementations, the view orientation tool can be used to set, in real time as the panoramic video plays, the Euler angles to be stored in the orientation data. The orientation data can then be used to recreate the view orientations for each point in time during the panoramic video playback. During video playback the camera's orientation can be rotated relative to the three-dimensional mesh based on the stored Euler angles. In some other implementations, the orientation data only includes Euler angles for one or more specific points in time during the panoramic video playback.

In some implementations, the thumbnail creation tool shows a preview of the frame at the selected time and camera orientation of the panoramic video. The thumbnail creation tool can re-render each frame of the panoramic video when reselected to update the preview.

A user of the view orientation tool can use a time selection interface to first select a point in time in the video. For example, the time selection interface can be a slider mechanism to select or adjust/reselect a time between the beginning and the end of the video. A use can click and drag a handle on a slider to scroll from the beginning to the end of the video. The furthest position left on the slider can be at the beginning of the video. The furthest position right on the slider can be at the end of the video. Once a point in time is selected, the user can then select Euler angles for that point in time.

In some implementations, the user can click and drag a mouse cursor's position across a viewing plane to adjust a camera orientation and zoom level. For example, clicking and dragging the mouse cursor along the X and Y axis of a two-dimensional screen can rotate the camera orientation around the X and Y rotational axis in three-dimensional space. The view orientation tool can calculate the amount of rotation of the camera orientation based on a distance of travel of the mouse cursor in the two-dimensional screen. In some implementations, the user can zoom in or out of the camera view using at least one of keyboard, mouse, touchscreen, trackball, joystick, or other input device. In some implementations, the view selection interface can include text boxes for a user to manually enter the orientation by typing in Euler angles desired.

In some implementations, the view orientation tool can be used to adjust a zoom level for one or more points in time of a panoramic video. For example, the view orientation tool can set a default zoom for one or more specific points in time of the panoramic video to help direct the viewer to areas of interest (e.g., wide landscape shots may be best viewed zoomed-out, while texture details may be best viewed zoomed-in). The view parameters further includes zoom parameters in addition to the orientation data.

In the implementations where the thumbnail creation tool and view orientation tool are combined into a single user interface, the time selection interfaces and the view selection interfaces for the thumbnail creation tool and view orientation tool are also combined.

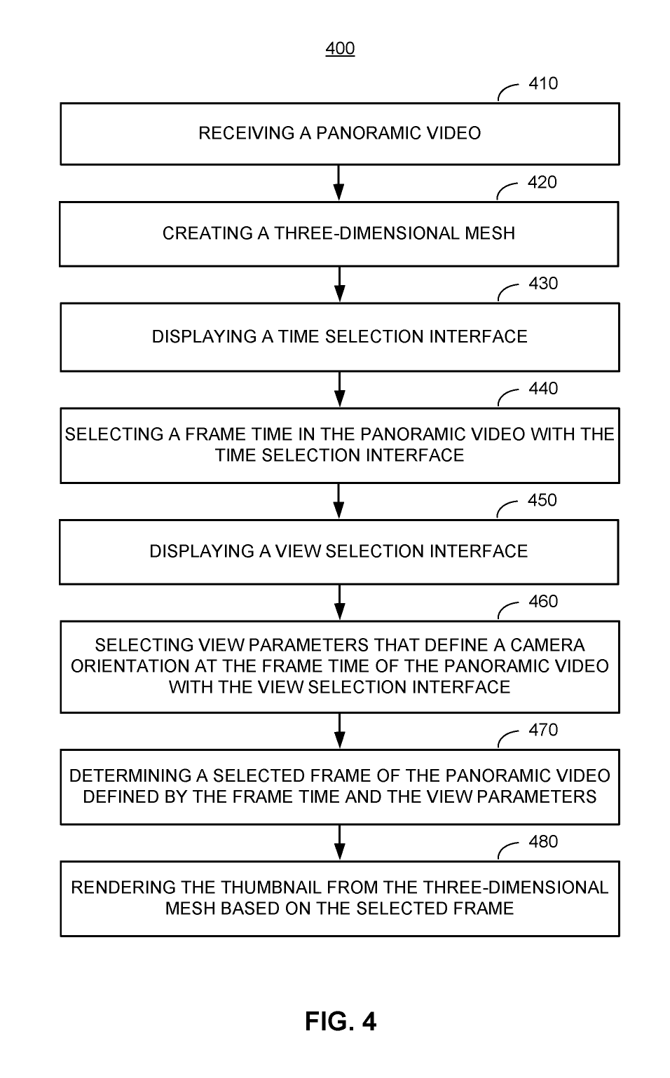

FIG. 4 illustrates an example methodology 400 for creating a thumbnail for a panoramic video. At step 410, a playback initialization tool receives a panoramic video. At step 420, the playback initialization tool creates a three-dimensional mesh. At step 430, the playback initialization tool displays a time selection interface. At step 440, the playback initialization tool selects a frame time in the panoramic video with the time selection interface. At step 450, the playback initialization tool displays a view selection interface. At step 460, the playback initialization tool selects view parameters that define a camera orientation at the frame time of the panoramic video with the view selection interface. At step 470, the playback initialization tool determines a selected frame of the panoramic video defined by the frame time and the view parameters. At step 480, the playback initialization tool renders the thumbnail from the three-dimensional mesh based on the selected frame.

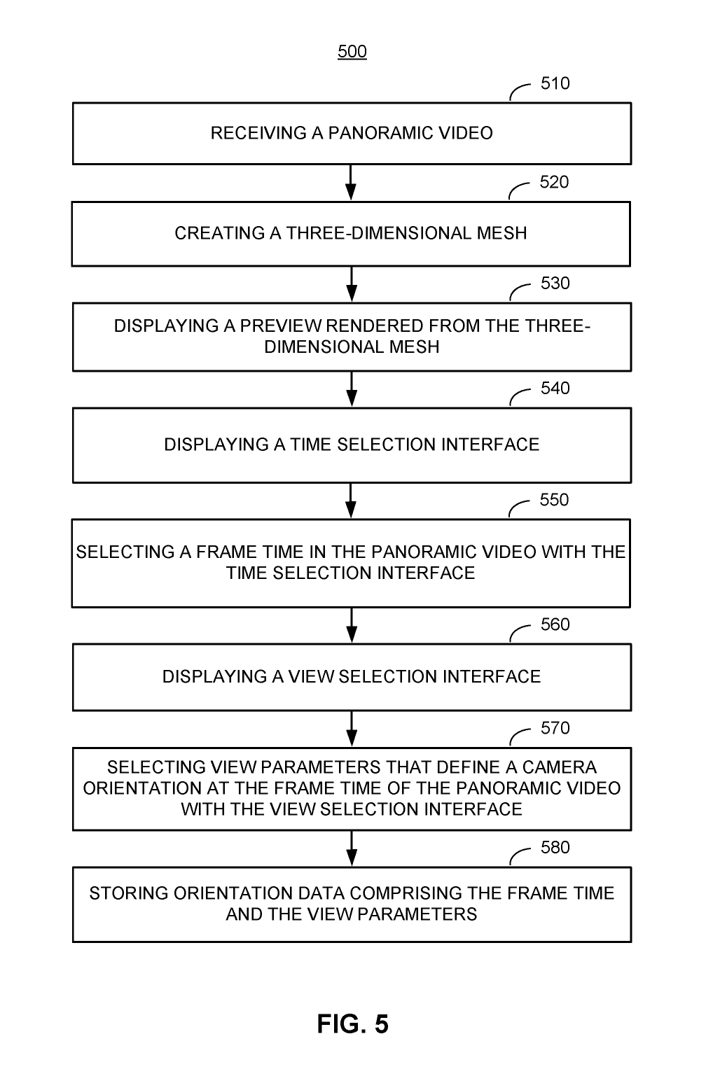

FIG. 5 illustrates an example methodology 500 for setting camera orientation for a panoramic video. At step 510, the view orientation tool receives a panoramic video. At step 520, the view orientation tool creates a three-dimensional mesh. At step 530, the view orientation tool displays a preview rendered from the three-dimensional mesh. At step 540, the view orientation tool displays a time selection interface. At step 550, a view orientation tool selects a frame time in the panoramic video with the time selection interface. At step 560, a view orientation tool displays a view selection interface. At step 570, a view orientation tool selects view parameters that define a camera orientation at the frame time of the panoramic video with the view selection interface. At step 580, a view orientation tool stores orientation data comprising the frame time and the view parameters.

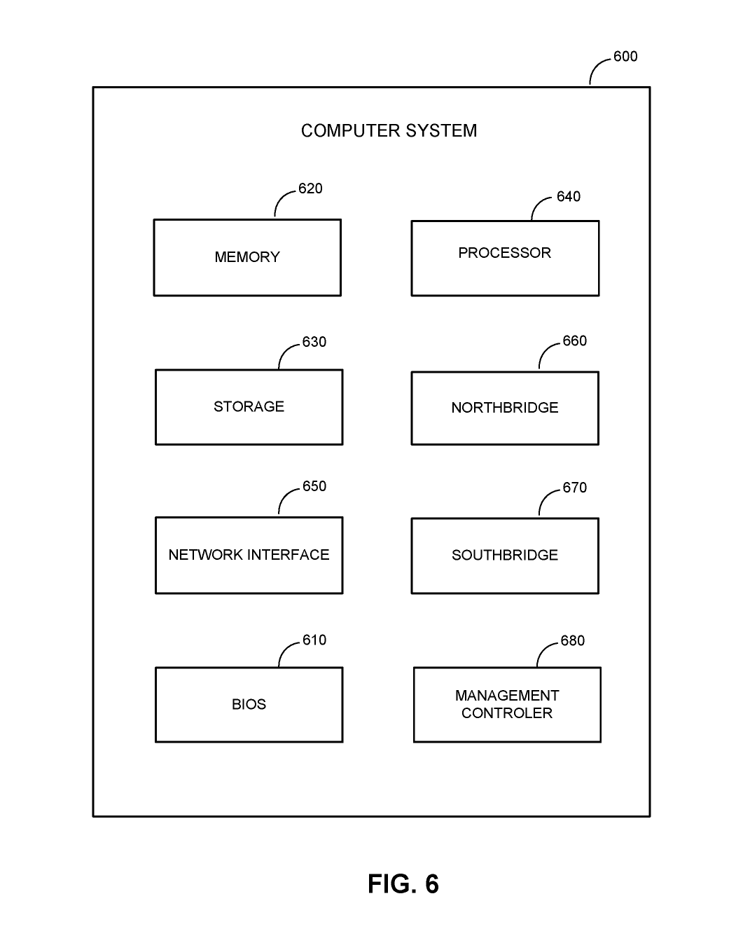

FIG. 6 illustrates a block diagram of an example computer system 600. The computer system 600 can include a processor 640, a network interface 650, a management controller 680, a memory 620, a storage 630, a Basic Input/Output System (BIOS) 610, and a northbridge 660, and a southbridge 670.

The computer system 600 can be, for example, a server (e.g., one of many rack servers in a data center) or a personal computer. The processor (e.g., central processing unit (CPU)) 640 can be a chip on a motherboard that can retrieve and execute programming instructions stored in the memory 620. The processor 640 can be a single CPU with a single processing core, a single CPU with multiple processing cores, or multiple CPUs. One or more buses (not shown) can transmit instructions and application data between various computer components such as the processor 640, memory 620, storage 630, and networking interface 650.

The memory 620 can include any physical device used to temporarily or permanently store data or programs, such as various forms of random-access memory (RAM). The storage 630 can include any physical device for non-volatile data storage such as a HDD or a flash drive. The storage 630 can have a greater capacity than the memory 620 and can be more economical per unit of storage, but can also have slower transfer rates.

The BIOS 610 can include a Basic Input/Output System or its successors or equivalents, such as an Extensible Firmware Interface (EFI) or Unified Extensible Firmware Interface (UEFI). The BIOS 610 can include a BIOS chip located on a motherboard of the computer system 600 storing a BIOS software program. The BIOS 610 can store firmware executed when the computer system is first powered on along with a set of configurations specified for the BIOS 610. The BIOS firmware and BIOS configurations can be stored in a non-volatile memory (e.g., NVRAM) 612 or a ROM such as flash memory. Flash memory is a non-volatile computer storage medium that can be electronically erased and reprogrammed.

The BIOS 610 can be loaded and executed as a sequence program each time the computer system 600 is started. The BIOS 610 can recognize, initialize, and test hardware present in a given computing system based on the set of configurations. The BIOS 610 can perform self-test, such as a Power-on-Self-Test (POST), on the computer system 600. This self-test can test functionality of various hardware components such as hard disk drives, optical reading devices, cooling devices, memory modules, expansion cards and the like. The BIOS can address and allocate an area in the memory 620 in to store an operating system. The BIOS 610 can then give control of the computer system to the OS.

The BIOS 610 of the computer system 600 can include a BIOS configuration that defines how the BIOS 610 controls various hardware components in the computer system 600. The BIOS configuration can determine the order in which the various hardware components in the computer system 600 are started. The BIOS 610 can provide an interface (e.g., BIOS setup utility) that allows a variety of different parameters to be set, which can be different from parameters in a BIOS default configuration. For example, a user (e.g., an administrator) can use the BIOS 610 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 680 can be a specialized microcontroller embedded on the motherboard of the computer system. For example, the management controller 680 can be a BMC or a RMC. The management controller 680 can manage the interface between system management software and platform hardware. Different types of sensors built into the computer system can report to the management controller 680 on parameters such as temperature, cooling fan speeds, power status, operating system status, etc. The management controller 680 can monitor the sensors and have the ability to send alerts to an administrator via the network interface 650 if any of the parameters do not stay within preset limits, indicating a potential failure of the system. The administrator can also remotely communicate with the management controller 680 to take some corrective action such as resetting or power cycling the system to restore functionality.

The northbridge 660 can be a chip on the motherboard that can be directly connected to the processor 640 or can be integrated into the processor 640. In some instances, the northbridge 660 and the southbridge 670 can be combined into a single die. The northbridge 660 and the southbridge 670, manage communications between the processor 640 and other parts of the motherboard. The northbridge 660 can manage tasks that require higher performance than the southbridge 670. The northbridge 660 can manage communications between the processor 640, the memory 620, and video controllers (not shown). In some instances, the northbridge 660 can include a video controller.

The southbridge 670 can be a chip on the motherboard connected to the northbridge 660, but unlike the northbridge 660, is not directly connected to the processor 640. The southbridge 670 can manage input/output functions (e.g., audio functions, BIOS, Universal Serial Bus (USB), Serial Advanced Technology Attachment (SATA), Peripheral Component Interconnect (PCI) bus, PCI eXtended (PCI-X) bus, PCI Express bus, Industry Standard Architecture (ISA) bus, Serial Peripheral Interface (SPI) bus, Enhanced Serial Peripheral Interface (eSPI) bus, System Management Bus (SMBus), etc.) of the computer system 600. The southbridge 670 can be connected to or can include within the southbridge 670 the management controller 670, Direct Memory Access (DMAs) controllers, Programmable Interrupt Controllers (PICs), and a real-time clock.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for creating a thumbnail for a panoramic video, by a playback initialization tool, comprising:
receiving a panoramic video;
creating a three-dimensional mesh;
displaying a time selection interface;
selecting a frame time in the panoramic video with the time selection interface;
displaying a view selection interface;
selecting view parameters that define a camera orientation at the frame time of the panoramic video with the view selection interface;
determining a selected frame of the panoramic video defined by the frame time and the view parameters; and
rendering the thumbnail from the three-dimensional mesh based on the selected frame.

2. The method of claim 1, further comprising storing video frames at a regular time interval and wherein the selecting the frame time is at one of the regular time interval.

3. The method of claim 1, further comprising displaying a preview rendered from the three-dimensional mesh.

4. The method of claim 1, wherein the time selection interface comprises a slider mechanism for selecting a frame time between a beginning and an end of the panoramic video.

5. The method of claim 1, wherein the view parameters includes at least one of pan, tilt, roll, or zoom parameters.

6. The method of claim 1, wherein selecting the view parameters comprises dragging a cursor's position across a camera viewing plane to rotate a camera orientation of the thumbnail.

7. The method of claim 1, further comprising re-rendering the thumbnail when the frame time and/or the view parameters are adjusted.

8. The method of claim 1, wherein the time selection interface and view selection interface are combined into a single user interface.

9. The method of claim 1, wherein the three-dimensional mesh is one of a Face-vertex mesh, a Winged-edge mesh, a Half-edge mesh, a Quad-edge mesh, a Corner-table mesh, and a Vertex-vertex mesh.

10. A method for setting camera orientation for a panoramic video, by a view orientation tool, comprising:
receiving a panoramic video;
creating a three-dimensional mesh;
displaying a preview rendered from the three-dimensional mesh;
displaying a time selection interface;
selecting a frame time in the panoramic video with the time selection interface;
displaying a view selection interface;
selecting view parameters that define a camera orientation at the frame time of the panoramic video with the view selection interface; and
storing orientation data comprising the frame time and the view parameters.

11. The method of claim 1, wherein the frame time selected is for a beginning of the panoramic video.

12. The method of claim 1, wherein the time selection interface comprises a slider mechanism for selecting a frame time between a beginning and an end of the panoramic video.

13. The method of claim 1, wherein the view parameters includes at least one of pan, tilt, roll, or zoom parameters.

14. The method of claim 1, wherein selecting the view parameters comprises dragging a cursor's position across a camera viewing plane to rotate a camera orientation.

15. The method of claim 1, further comprising re-rendering the preview when the frame time and/or the view parameters are adjusted.

16. The method of claim 1, wherein the time selection interface and view selection interface are combined into a single user interface.

17. The method of claim 1, wherein the three-dimensional mesh is one of a Face-vertex mesh, a Winged-edge mesh, a Half-edge mesh, a Quad-edge mesh, a Corner-table mesh, and a Vertex-vertex mesh.

18. A method for initializing a panoramic video, comprising:
receiving a panoramic video;
creating a three-dimensional mesh;
displaying a preview rendered from the three-dimensional mesh;
displaying a time selection interface;
selecting a frame time in the panoramic video with the time selection interface;
displaying a view selection interface;
selecting view parameters that define a camera orientation at the frame time of the panoramic video with the view selection interface;
determining a selected frame of the panoramic video defined by the frame time and the view parameters;
rendering the thumbnail from the three-dimensional mesh based on the selected frame; and
storing orientation data comprising the frame time and the view parameters.
